(19) United States
(12) Patent Application Publication
(10) Pub. No.: US 2012/0240058 A1
(43) Pub. Date: Sep. 20, 2012

(54) DETECTING AND DISPLAYING USER STATUS

(75) Inventors: Al Chakra, Apex, NC (US); Wen Hao Wang, Beijing (CN)

(73) Assignee: International Business Machines Corporation, Armonk, NY (US)

(21) Appl. No.: 13/049,860

(22) Filed: Mar. 16, 2011

(51) Int. Cl. G06F 3/01; G06F 15/16

(52) U.S. Cl. 715/753

(57) ABSTRACT

A method, computer program product, and system for detecting and displaying user status is described. A method may comprise receiving activity data from at least one of an audio input device, a video input device, and a command input device. The method may further comprise calculating a text availability index corresponding, at least in part, to a likelihood of a user to be available for text communication, a voice availability index corresponding, at least in part, to a likelihood of the user to be available for voice communication, and a video availability index corresponding, at least in part to a likelihood of the user to be available for video communication, wherein at least one of the text availability index, the voice availability index, and the video availability index is based upon, at least in part, the activity data.

### BACKGROUND OF THE INVENTION

An individual may be able or unable to communicate electronically by text/instant message, voice, and/or video for various reasons. The individual's communication status may be displayed for others to view, but the communication status may be binary. In other words, the communication status may show whether the individual is available or unavailable for communication without respect to any specific type of electronic communication. Further, the individual may be more able to communicate via one type of electronic communication, and less able to communicate via another type.

### BRIEF SUMMARY OF THE INVENTION

In a first embodiment, a method may include receiving, via a computing device, activity data from at least one of an audio input device, a video input device, and a command input device. The method may further include calculating a text availability index corresponding, at least in part, to a likelihood of a user to be available for text communication, a voice availability index corresponding, at least in part, to a likelihood of the user to be available for voice communication, and a video availability index corresponding, at least in part to a likelihood of the user to be available for video communication, wherein at least one of the text availability index, the voice availability index, and the video availability index is based upon, at least in part, the activity data. The method may also include rendering a graphic indicator associated with the text availability index, the voice availability index, and the video availability index, wherein the graphic indicator indicates, at least in part, the likelihood of the user to be available for text communication, the likelihood of the user to be available for voice communication, and the likelihood of the user to be available for video communication.

One or more of the following features may be included. The graphic indicator may include a text color shade associated with the text availability index, the text color shade indicating, at least in part, the likelihood of the user to be available for text communication, a voice color shade associated with the voice availability index, the voice color shade indicating, at least in part, the likelihood of the user to be available for voice communication, and a video color shade associated with the video availability index, the video color shade indicating, at least in part, the likelihood of the user to be available for video communication. The graphic indicator may also include a combined color shade, the combined color shade based upon, at least in part, the text availability index, the voice availability index, and the video availability index, the combined color shade indicating, at least in part, the likelihood of the user to be available for text communication, the likelihood of the user to be available for voice communication, and the likelihood of the user to be available for video communication.

In some implementations, the method may further include storing values of at least one of the text availability index, the voice availability index, and the video availability index over a historical trend time period. The method may also include calculating at least one of: a text availability metric based upon, at least in part, the stored values of the text availability index over the historical trend time period, a voice availability metric based upon, at least in part, the stored values of the voice availability index over the historical trend time period, a video availability metric based upon, at least in part, the stored values of the video availability index over the historical trend time period. Moreover, the method may include providing an indication of at least one of the text availability metric, the voice availability metric, and the video availability metric, the indication corresponding, at least in part, to a historical likelihood of the user to be available for at least one of text communication, voice communication, and video communication. The method may further include identifying a facial expression trend based upon, at least in part, the activity data. The method may additionally include providing an indication of a deviation from the facial expression trend if a detected facial expression deviates from the facial expression trend. At least one of the text availability index corresponding, at least in part, to the likelihood of a user to be available for text communication, the voice availability index corresponding, at least in part, to the likelihood of the user to be available for voice communication, and the video availability index corresponding, at least in part to the likelihood of the user to be available for video communication may be further based upon, at least in part, at least one of processor utilization, network speed, a scheduled calendar meeting, and a screen lock status. The graphic indicator including the combined color shade that indicates, at least in part, the likelihood of the user to be available for text communication, the likelihood of the user to be available for voice communication, and the likelihood of the user to be available for video communication, may be displayed in an availability status icon associated with an instant message application, and the instant message application may be configured for text communication, voice communication, and video communication.

In a second embodiment, a computer program product may reside on a computer readable storage medium and may have a plurality of instructions stored on it. When executed by a processor, the instructions may cause the processor to perform operations including receiving activity data from at least one of an audio input device, a video input device, and a command input device. The operations may further include calculating a text availability index corresponding, at least in part, to a likelihood of a user to be available for text communication, a voice availability index corresponding, at least in part, to a likelihood of the user to be available for voice communication, and a video availability index corresponding, at least in part to a likelihood of the user to be available for video communication, wherein at least one of the text availability index, the voice availability index, and the video availability index is based upon, at least in part, the activity data. The operations may also include rendering a graphic indicator associated with the text availability index, the voice availability index, and the video availability index, wherein the graphic indicator indicates, at least in part, the likelihood of the user to be available for text communication, the likelihood of the user to be available for voice communication, and the likelihood of the user to be available for video communication.

One or more of the following features may be included. The graphic indicator may include a text color shade associated with the text availability index, the text color shade indicating, at least in part, the likelihood of the user to be available for text communication, a voice color shade associated with the voice availability index, the voice color shade indicating, at least in part, the likelihood of the user to be available for voice communication, and a video color shade associated with the video availability index, the video color shade indicating, at least in part, the likelihood of the user to be available for video communication. The graphic indicator may also include a combined color shade, the combined color shade based upon, at least in part, the text availability index, the voice availability index, and the video availability index, the combined color shade indicating, at least in part, the likelihood of the user to be available for text communication, the likelihood of the user to be available for voice communication, and the likelihood of the user to be available for video communication.

In some implementations, the operations may further include storing values of at least one of the text availability index, the voice availability index, and the video availability index over a historical trend time period. The operations may also include calculating at least one of: a text availability metric based upon, at least in part, the stored values of the text availability index over the historical trend time period, a voice availability metric based upon, at least in part, the stored values of the voice availability index over the historical trend time period, a video availability metric based upon, at least in part, the stored values of the video availability index over the historical trend time period. Moreover, the operations may include providing an indication of at least one of the text availability metric, the voice availability metric, and the video availability metric, the indication corresponding, at least in part, to a historical likelihood of the user to be available for at least one of text communication, voice communication, and video communication. The operations may further include identifying a facial expression trend based upon, at least in part, the activity data. The operations may additionally include providing an indication of a deviation from the facial expression trend if a detected facial expression deviates from the facial expression trend. At least one of the text availability index corresponding, at least in part, to the likelihood of a user to be available for text communication, the voice availability index corresponding, at least in part, to the likelihood of the user to be available for voice communication, and the video availability index corresponding, at least in part to the likelihood of the user to be available for video communication may be further based upon, at least in part, at least one of processor utilization, network speed, a scheduled calendar meeting, and a screen lock status. The graphic indicator including the combined color shade that indicates, at least in part, the likelihood of the user to be available for text communication, the likelihood of the user to be available for voice communication, and the likelihood of the user to be available for video communication, may be displayed in an availability status icon associated with an instant message application, and the instant message application may be configured for text communication, voice communication, and video communication.

In a third embodiment, a computing system is provided. The computing system may include at least one processor and at least one memory architecture coupled with the at least one processor. The computing system may also include a first software module executable by the at least one processor and the at least one memory architecture, wherein the first software module may be configured to receive activity data from at least one of an audio input device, a video input device, and a command input device. Further, the computing system may include a second software module which may be configured to calculate a text availability index corresponding, at least in part, to a likelihood of a user to be available for text communication, a voice availability index corresponding, at least in part, to a likelihood of the user to be available for voice communication, and a video availability index corresponding, at least in part to a likelihood of the user to be available for video communication, wherein at least one of the text availability index, the voice availability index, and the video availability index is based upon, at least in part, the activity data. Additionally, the computing system may include a third software module which may be configured to render a graphic indicator associated with the text availability index, the voice availability index, and the video availability index, wherein the graphic indicator indicates, at least in part, the likelihood of the user to be available for text communication, the likelihood of the user to be available for voice communication, and the likelihood of the user to be available for video communication.

One or more of the following features may be included. The graphic indicator may include a text color shade associated with the text availability index, the text color shade indicating, at least in part, the likelihood of the user to be available for text communication, a voice color shade associated with the voice availability index, the voice color shade indicating, at least in part, the likelihood of the user to be available for voice communication, and a video color shade associated with the video availability index, the video color shade indicating, at least in part, the likelihood of the user to be available for video communication. The graphic indicator may also include a combined color shade, the combined color shade based upon, at least in part, the text availability index, the voice availability index, and the video availability index, the combined color shade indicating, at least in part, the likelihood of the user to be available for text communication, the likelihood of the user to be available for voice communication, and the likelihood of the user to be available for video communication.

In some implementations, the computing system may further include a fourth software module executable by the at least one processor and the at least one memory architecture, wherein the fourth software module may be configured to store values of at least one of the text availability index, the voice availability index, and the video availability index over a historical trend time period. Furthermore, a fifth software module may be configured to calculate at least one of: a text availability metric based upon, at least in part, the stored values of the text availability index over the historical trend time period, a voice availability metric based upon, at least in part, the stored values of the voice availability index over the historical trend time period, a video availability metric based upon, at least in part, the stored values of the video availability index over the historical trend time period. Moreover, a sixth software module may be configured to provide an indication of at least one of the text availability metric, the voice availability metric, and the video availability metric, the indication corresponding, at least in part, to a historical likelihood of the user to be available for at least one of text communication, voice communication, and video communication. The computing system may also include a seventh software module which may be configured to identify a facial expression trend based upon, at least in part, the activity data. Additionally, an eighth software module may be configured to provide an indication of a deviation from the facial expression trend if a detected facial expression deviates from the facial expression trend. At least one of the text availability index corresponding, at least in part, to the likelihood of a user to be available for text communication, the voice availability index corresponding, at least in part, to the likelihood of the user to be available for voice communication, and the video availability index corresponding, at least in part to the likelihood of the user to be available for video communication may be further based upon, at least in part, at least one of processor utilization, network speed, a scheduled calendar meeting, and a screen lock status.

The details of one or more implementations are set forth in the accompanying drawings and the description below. Other features and advantages will become apparent from the description, the drawings, and the claims.

### BRIEF DESCRIPTION OF THE SEVERAL VIEWS OF THE DRAWINGS

FIG. 1 is a diagrammatic view of a user status process coupled to a distributed computing network;

FIG. 2 is a flowchart of the user status process of FIG. 1;

FIG. 3 is an exemplary computer system which may be associated with the user status process of FIG. 1; and

FIG. 4 is also an exemplary graphical user interface which may be associated with the user status process of FIG. 1.

### DETAILED DESCRIPTION OF THE INVENTION

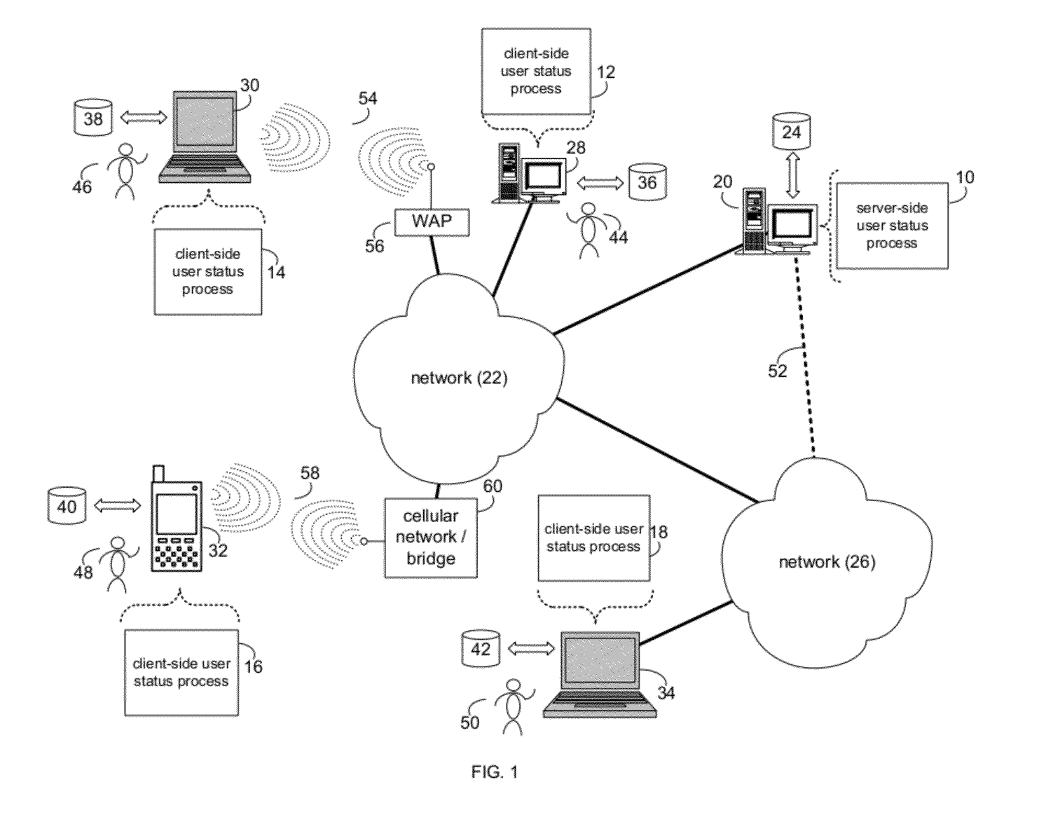

Referring to FIGS. 1 & 2, there is shown a user status process 12. As will be discussed below, user status process 12 may receive 100 activity data from at least one of an audio input device, a video input device, and a command input device. User status process 12 may also calculate 102 a text availability index corresponding, at least in part, to a likelihood of a user to be available for text communication, a voice availability index corresponding, at least in part, to a likelihood of the user to be available for voice communication, and a video availability index corresponding, at least in part to a likelihood of the user to be available for video communication, wherein at least one of the text availability index, the voice availability index, and the video availability index is based upon, at least in part, the activity data.

The user status (US) process may be a server-side process (e.g., server-side US process 10), a client-side process (e.g., client-side US process 12, client-side US process 14, client-side US process 16, or client-side US process 18), or a hybrid server-side/client-side process (e.g., the combination of server-side US process 10 and one or more of client-side US processes 12, 14, 16, 18).

Server-side US process 10 may reside on and may be executed by server computer 20, which may be connected to network 22 (e.g., the Internet or a local area network). Examples of server computer 20 may include, but are not limited to: a personal computer, a server computer, a series of server computers, a mini computer, and/or a mainframe computer. Server computer 20 may be a web server (or a series of servers) running a network operating system, examples of which may include but are not limited to: Microsoft® Windows Server®; Novell® Netware®; or Red Hat® Linux®, for example.

The instruction sets and subroutines of server-side US process 10, which may be stored on storage device 24 coupled to server computer 20, may be executed by one or more processors (not shown) and one or more memory architectures (not shown) incorporated into server computer 20. Storage device 24 may include but is not limited to: a hard disk drive; a tape drive; an optical drive; a RAID array; a random access memory (RAM); and a read-only memory (ROM).

Server computer 20 may execute a web server application, examples of which may include but are not limited to: Microsoft® IIS, Novell® Web Server, or Apache® Web Server, that allows for access to server computer 20 (via network 22) using one or more protocols, examples of which may include but are not limited to HTTP (i.e., HyperText Transfer Protocol), SIP (i.e., session initiation protocol), and the Lotus® Sametime® VP protocol. Network 22 may be connected to one or more secondary networks (e.g., network 26), examples of which may include but are not limited to: a local area network; a wide area network; or an intranet, for example.

Client-side US processes 12, 14, 16, 18 may reside on and may be executed by client electronic devices 28, 30, 32, and/or 34 (respectively), examples of which may include but are not limited to personal computer 28, laptop computer 30, a data-enabled mobile telephone 32, notebook computer 34, personal digital assistant (not shown), smart phone (not shown) and a dedicated network device (not shown), for example. Client electronic devices 28, 30, 32, 34 may each be coupled to network 22 and/or network 26 and may each execute an operating system, examples of which may include but are not limited to Microsoft® Windows®, Microsoft Windows CE®, Red Hat® Linux®, or a custom operating system.

The instruction sets and subroutines of client-side US processes 12, 14, 16, 18, which may be stored on storage devices 36, 38, 40, 42 (respectively) coupled to client electronic devices 28, 30, 32, 34 (respectively), may be executed by one or more processors (not shown) and one or more memory architectures (not shown) incorporated into client electronic devices 28, 30, 32, 34 (respectively). Storage devices 36, 38, 40, 42 may include but are not limited to: hard disk drives; tape drives; optical drives; RAID arrays; random access memories (RAM); read-only memories (ROM); compact flash (CF) storage devices; secure digital (SD) storage devices; and memory stick storage devices.

Client-side US processes 12, 14, 16, 18 and/or server-side US process 10 may be processes that run within (i.e., are part of) a recording and/or summarizing application. Alternatively, client-side US processes 12, 14, 16, 18 and/or server-side US process 10 may be stand-alone applications that work in conjunction with the recording and/or summarizing application. One or more of client-side US processes 12, 14, 16, 18 and server-side US process 10 may interface with each other (via network 22 and/or network 26).

Users 44, 46, 48, 50 may access server-side US process 10 directly through the device on which the client-side US process (e.g., client-side US processes 12, 14, 16, 18) is executed, namely client electronic devices 28, 30, 32, 34, for example. Users 44, 46, 48, 50 may access server-side US process 10 directly through network 22 and/or through secondary network 26. Further, server computer 20 (i.e., the computer that executes server-side US process 10) may be connected to network 22 through secondary network 26, as illustrated with phantom link line 52.

The various client electronic devices may be directly or indirectly coupled to network 22 (or network 26). For example, personal computer 28 is shown directly coupled to network 22 via a hardwired network connection. Further, notebook computer 34 is shown directly coupled to network 26 via a hardwired network connection. Laptop computer 30 is shown wirelessly coupled to network 22 via wireless communication channel 54 established between laptop computer 30 and wireless access point (i.e., WAP) 56, which is shown directly coupled to network 22. WAP 56 may be, for example, an IEEE 802.11a, 802.11b, 802.11g, 802.11n, Wi-Fi, and/or Bluetooth device that is capable of establishing wireless communication channel 54 between laptop computer 30 and WAP 56. Data-enabled mobile telephone 32 is shown wirelessly coupled to network 22 via wireless communication channel 58 established between data-enabled mobile telephone 32 and cellular network/bridge 60, which is shown directly coupled to network 22.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

### The User Status (US) Process

For the following discussion, client-side US process 12 will be described for illustrative purposes. It should be noted that client-side US process 12 may be incorporated into server-side US process 10 and may be executed within one or more applications that allow for communication with client-side US process 12. However, this is not intended to be a limitation of this disclosure, as other configurations are possible (e.g., stand-alone, client-side US processes and/or stand-alone server-side US processes.) For example, some implementations may include one or more of client-side US processes 14, 16, 18 in place of or in addition to client-side US process 12.

Electronic communication between colleagues and friends may be a common form of communication. Electronic communications may include text communication, voice communication, and video communication. Text communication may include email, instant message, and/or text message communication. Voice communication may include telephone, voice-over-IP, and various internet-based voice communications. Video communication may include web conferencing, online meetings, and face to face voice and/or chat communications over computer systems which may use various video input devices. While trying to electronically communicate with colleagues and/or friends, users may wish to know not only whether or not someone is available for electronic communication (e.g., online/offline), but may also wish to know the likelihood that someone is available for communication via a specific type of electronic communication, such as text communication, voice communication, or video communication.

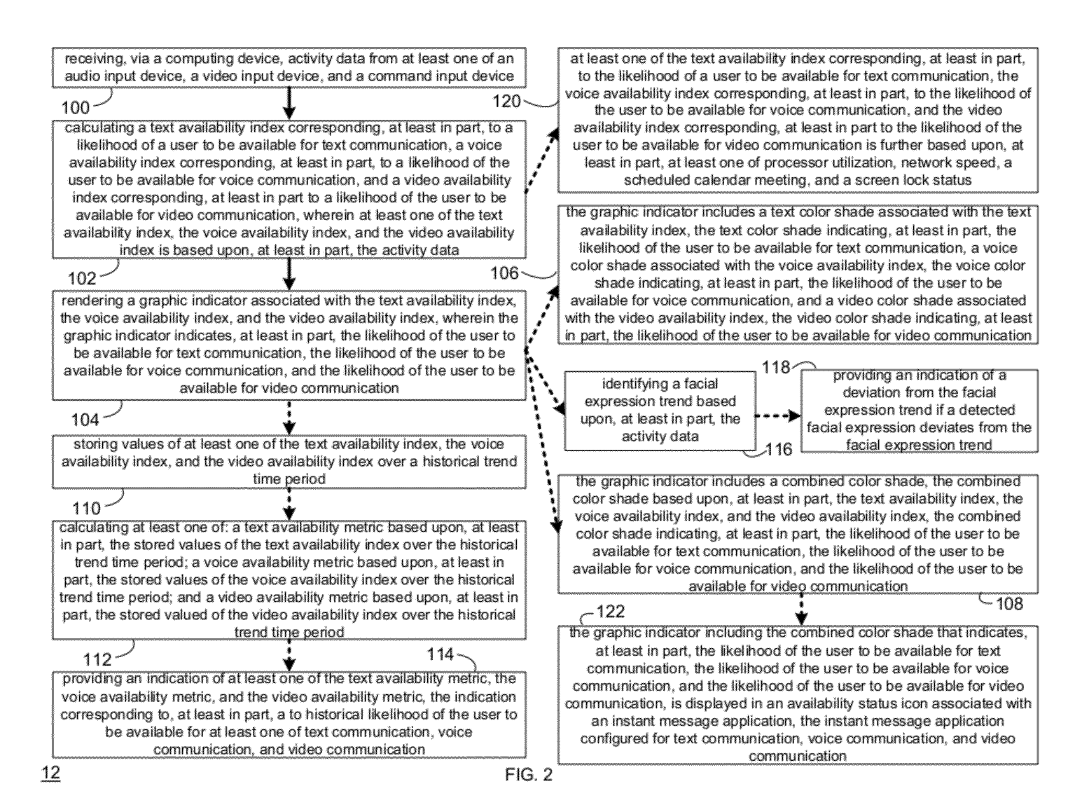

Referring now to FIGS. 1-3, US process 12 may receive 100 activity data from at least one of an audio input device (e.g., microphone 302), a video input device (e.g., video camera 304), and a command input device (e.g., mouse 306 and/or keyboard 308). Microphone 302, video camera 304, mouse 306 and/or keyboard 308 may be in electronic communication with a client electronic device such as computer system 300. Activity data may be information received through one or more of microphone 302, video camera 304, mouse 306 and/or keyboard 308, such as audio data, video data, and/or data input through mouse 306 and/or keyboard 308. While microphone 302, video camera 304, mouse 306 and/or keyboard 308 are discussed herein as inputs through which activity data may be received, other devices such as trackballs, motion detection devices, touch screen devices, and game controllers may be used. In an implementation, any type of input device may be used as input through which activity data may be received. Additionally, while computer system 300 is discussed herein, any one of the client electronic devices discussed above may be used in connection with the audio input devices, video input devices, and command input devices, to receive various types of activity data.

Further, US process 12 may calculate 102 a text availability index corresponding, at least in part, to a likelihood of a user to be available for text communication, a voice availability index corresponding, at least in part, to a likelihood of the user to be available for voice communication, and a video availability index corresponding, at least in part to a likelihood of the user to be available for video communication, wherein at least one of the text availability index, the voice availability index, and the video availability index is based upon, at least in part, the activity data. The text availability index may be based upon, at least in part, a frequency of user mouse operations and/or a frequency of user keyboard operations. For example, if a user of computer system 300 depresses mouse buttons (e.g., mouse buttons 312/314 of mouse 306), the frequency (e.g., fₘ as discussed herein) of the user's activity on mouse 306 may be received as activity data by US process 12. Similarly, if a user of computer system 300 types on keyboard 308 and depresses various keys (e.g., key 310), the frequency (e.g., fₖ as discussed herein) of the user's activity on keyboard 308 may be received as activity data by US process 12.

The voice availability index may be based upon, at least in part, a sound intensity received from an audio input device (e.g., microphone 302). For example, if the user is in a noisy place, the sound intensity (e.g., I as discussed herein) may be high. Sound intensity I may be received as activity data by US process 12. Further, the video availability index may be based upon, at least in part, activity data received through the video input device (e.g. video camera 304). The video availability index may also be based upon, at least in part, a network speed (e.g., Sₙ) between the user of computer system 300 and another user. It should be noted that while the text availability index may be based upon fₘ and/or fₖ, the voice availability index may be based upon I, and the video availability index may be based upon activity data received through the video input device and/or Sₙ, as discussed above, these are not meant to be limitations of the present disclosure.

For example, any one of the text availability index, the voice availability index, and the video availability index may be based upon, at least on part, one or more of fₘ, fₖ, I, activity data received though the video input device, Sₙ, or other activity data. Other activity data may include, but is not limited to, processor utilization (e.g., of a processor associated with computer system 300), network speed (e.g., between systems of two users), a scheduled calendar meeting (e.g., calendar meeting 316 shown in calendar 318), and a screen lock status. In this way, at least one of the text availability index corresponding, at least in part, to the likelihood of a user to be available for text communication, the voice availability index corresponding, at least in part, to the likelihood of the user to be available for voice communication, and the video availability index corresponding, at least in part to the likelihood of the user to be available for video communication may be (120) based upon, at least in part, at least one of processor utilization, network speed, a scheduled calendar meeting, and a screen lock status.

Other information detected by one or more of microphone 302, video camera 304, mouse 306 and/or keyboard 308 may be analyzed and used by US process 12 to provide a more accurate text availability index, voice availability index, and/or video availability index. For example US process 12 may detect via microphone 302 and/or video camera 304 that a user is speaking. This may indicate that the user is busy speaking to someone in their office and as such may indicate a lower voice availability index. US process 12 may also detect via microphone 302 and/or video camera 304 that multiple individuals are sitting closely near a user's computer. This may indicate that the user is in a meeting and may indicate a lower text availability index, voice availability index, and video availability index. US process 12 may further detect via video camera 304 that a user is holding a telephone receiver. This may indicate that the user is on a telephone call and may indicate a low voice availability index. It may also indicate a low text availability index and a low video availability index. US process 12 may also detect via video camera 304 that the user is eating and/or sleeping. This may indicate a lower text availability index, voice availability index, and video availability index. US process 12 may additionally detect a large frequency of keyboard and/or mouse action. This may indicate that the user is working on something important, and may indicate a lower text availability index, voice availability index, and video availability index. Further, US process 12 may detect that the network speed of the user's network is slow. This may indicate a lower video availability index.

Calculation and/or computation of the text availability index, the voice availability index, and the video availability index may be performed in a variety of ways. The methods discussed herein describing such calculations are for exemplary purposes only. In an implementation, US process 12 may start with a default value for each of the text availability index, the voice availability index, and the video availability index. The text availability index, the voice availability index, and/or the video availability index may be calculated as the sum of the default index value (e.g., D) and an emending index value (e.g., E). The emending index value may represent a value for a scenario discussed above (e.g., detecting that the user is eating or sleeping). For example, the emending index value may be related to a high level of volume detected via microphone 302. US process 12 may monitor the user's environment and calculate the text availability index, the voice availability index, and the video availability index as frequently as desired by the user in order to provide accurate availability indexes to the user.

US process 12 may show a user's relative text availability index, voice availability index, and video availability index by displaying different shades of colors associated with each index. For example, each possible index value may have one corresponding color defined in an electronic communication application. A user displaying dark red may indicate that the user is highly available, and a user displaying light red may indicate that the user is essentially unavailable. In other words, each of the text availability index, the voice availability index, and the video availability index of a user may correspond to a color, and the darkness or lightness of the color may indicate that user's relative availability for that particular communication type.

US process 12 may further render 104 a graphic indicator (e.g., graphic indicators 324, 326, 328) associated with the text availability index, the voice availability index, and the video availability index, wherein the graphic indicator indicates, at least in part, the likelihood of the user to be available for text communication, the likelihood of the user to be available for voice communication, and the likelihood of the user to be available for video communication. Graphic indicators 324, 326, 328 may appear in contact list 322 and may indicate various communication statuses of a user's contacts. Contact list 322 may be associated with an integrated communications application and/or instant messaging application including, but not limited to, Lotus® Sametime®. For example, graphic indicator 324 may indicate that a user (i.e., Bobby) has a high text availability index, a medium voice availability index, and a low video availability index.

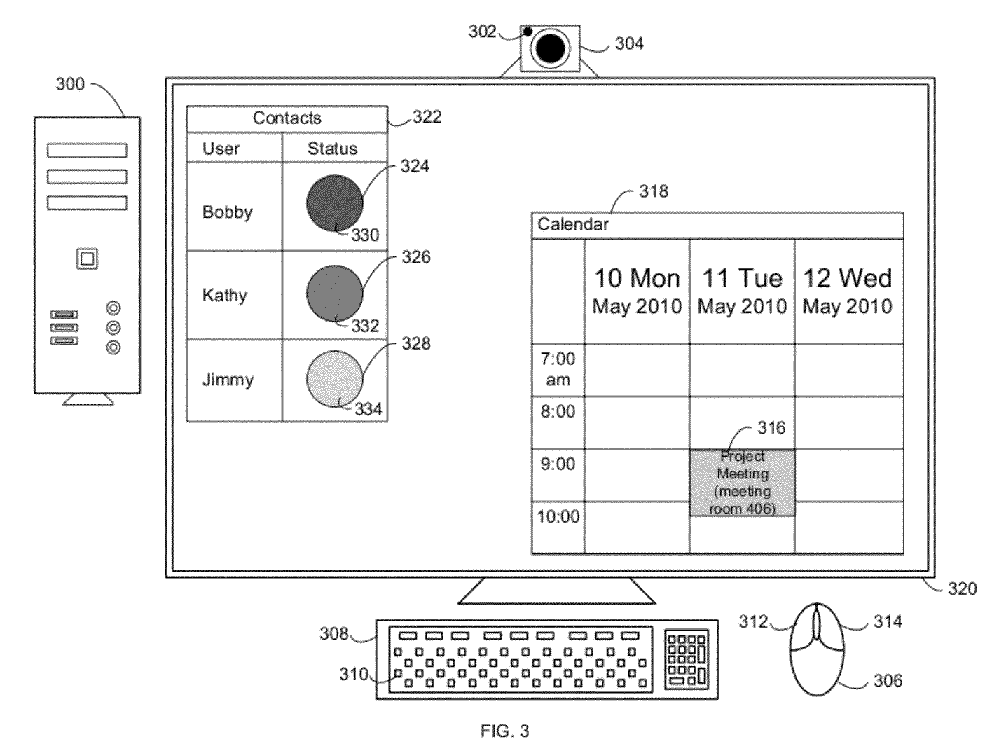

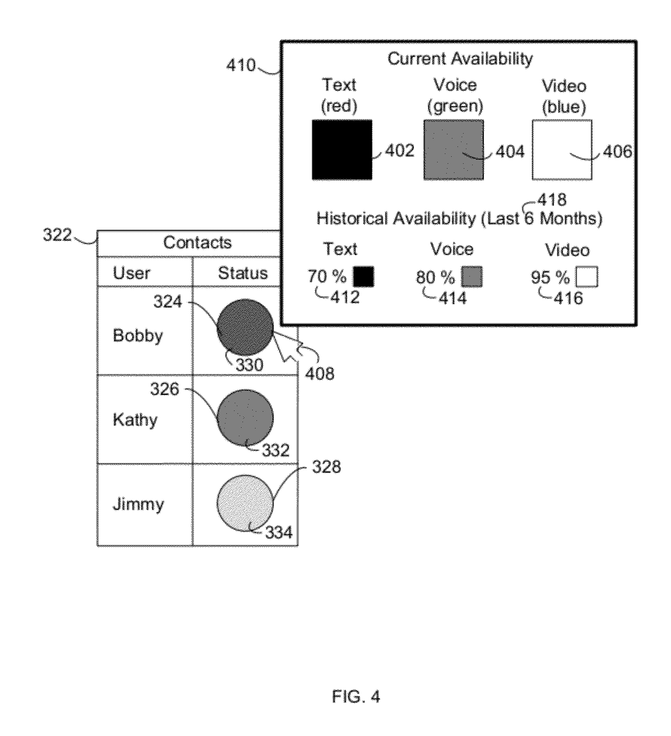

Graphic indicator 324 may include 108 a combined color shade (e.g., combined color shade 330). The combined color shade (e.g., combined color shade 330) may be based upon, at least in part, the text availability index, the voice availability index, and the video availability index. The combined color shade (e.g., combined color shade 330) may indicate, at least in part, the likelihood of the user to be available for text communication, the likelihood of the user to be available for voice communication, and the likelihood of the user to be available for video communication. In an implementation, the graphic indicator (e.g., graphic indicators 324, 326, 328) including the combined color shade (e.g., combined color shade 330) that indicates, at least in part, the likelihood of the user to be available for text communication, the likelihood of the user to be available for voice communication, and the likelihood of the user to be available for video communication may be displayed in an availability status icon (e.g., graphic indicator 324) associated with an instant message application. The instant message application may be configured for text communication, voice communication, and video communication. While the availability status icon is shown in contact list 322 of FIGS. 3 and 4 as being the graphic indicator (e.g., graphic indicator 324) itself, this is not meant to be a limitation of the present disclosure. For example, graphic indicator 324 may be a component of an availability status icon in an implementation.

Combined color shade 330 may be a shade that indicates a high text availability index, a medium voice availability index, and a low video availability index. Further, graphic indicator 326 may indicate that a user (i.e., Kathy) has a low text availability index, a high voice availability index, and a medium video availability index as color shade 332 may be a shade that indicates low text availability index, a high voice availability index, and a medium video availability index. Additionally, graphic indicator 328 may indicate that a user (i.e., Jimmy) has a medium text availability index, a low voice availability index, and a low video availability index, as color shade 334 may be a shade that indicates a medium text availability index, a low voice availability index, and a low video availability index.

Referring now also to FIG. 4, the graphic indicator (e.g., graphic indicator 324, 326, 328) may include 106 a text color shade (e.g., text color shade 402) associated with the text availability index, the text color shade (e.g., text color shade 402) indicating, at least in part, the likelihood of the user to be available for text communication, a voice color shade (e.g., voice color shade 404) associated with the voice availability index, the voice color shade (e.g., voice color shade 404) indicating, at least in part, the likelihood of the user to be available for voice communication, and a video color shade (e.g., video color shade 406) associated with the video availability index, the video color shade (e.g., video color shade 406) indicating, at least in part, the likelihood of the user to be available for video communication. Text color shade 402, voice color shade 404, and/or video color shade 406 may be viewed via popup 410, which may be rendered in response to hovering cursor 408 over a status indicator (e.g., graphic indicator 324) of contact list 322.

In an example, text color shade 402 may include a shade of red, where darker shades of red may indicate higher levels of the text availability index and may indicate that a user is highly available for text communication. Lighter shades of red may indicate lower levels of the text availability index and may indicate that a user is less available for text communication. Further, voice color shade 404 may include a shade of green, where darker shades of green may indicate higher levels of the voice availability index and may indicate that a user is highly available for voice communication. Lighter shades of green may indicate lower levels of the voice availability index and may indicate that a user is less available for voice communication. Video color shade 406 may include a shade of blue, where darker shades of blue may indicate higher levels of the video availability index and may indicate that a user is highly availably for video communication. Lighter shades of blue may indicate lower levels of the video availability index and may indicate that a user is less available for video communication. It should be noted that the colors and shade schemes discussed above are meant for illustrative purposes only, as other variations are possible. For example, different colors may be used to represent text communication, voice communication, and video communication availability, lighter shades may represent higher levels of availability rather than darker shades, and darker shades may represent lower levels of availability than lower shades.

Text color shade 402, voice color shade 404, and video color shade 406 may be merged by US process 12 into combined color shade 330. For example, if each of the text availability index, the voice availability index, and the video availability index corresponds to a particular shade of one color (e.g., red, green, and blue, respectively) in the tri-color display of combined color shade 330, then three weights may be available. Merging each particular shade of the respective color associated with the text availability index, the voice availability index, and the video availability index may generate a final color (e.g., combined color shade 330) that may show all three types of user availability status (e.g., text communication availability, voice communication availability, and video communication availability). In this way, US process 12 may allow a user to view all three availability indexes in one combined color shade (e.g., combined color shade 330).

US process 12 may use a 0-255-RGB color system in order to assign corresponding color shades to the text availability index, the voice availability index, and the video availability index. For example, the text availability index (TAI) may be represented by the formula:

TAI=255/(fₘ₊fₖ)

where, as discussed above, fₘ may represent a frequency of mouse operations and fₖ may represent a frequency of keyboard operations. If the user is already very busy using the mouse and keyboard, the user is unlikely to be available for text communication. Further, the voice availability index (VoAI) may be represented by the formula:

VoAI=255/I

where, as discussed above, I may represent a sound intensity. If the user is in a noisy environment, the user is unlikely to be available for voice communication. Additionally, the video availability index (ViAI) may be represented by the formula:

ViAI=255*log₂₅₅(Sₙ)

where Sₙ is a network speed between two users. If the network speed between the two users is fast, then video communication may be more possible.

In this way, text color shade 402, voice color shade 404, and video color shade 406 may be shown as corresponding shades of red, green, and blue, respectively, to indicate the text availability index, the voice availability index, and the video availability index, respectively, in a 0-255-RGB color scheme. Further, text color shade 402, voice color shade 404, and video color shade 406 may be merged to display combined color shade 330, where the color shown is represented by (0-255(Red), 0-255 (Green), 0-255 Blue)). It should be noted that the formulas described above are discussed for exemplary purposes only, and other formulas may be used to calculate the availability indexes. Further, it should be noted that in the formulas used above, lighter colors may represent higher levels of availability, while darker colors may represent lower levels of availability. In an example, RGB (255, 227, 132) may result in a shade of forum gold being displayed, which may indicate that the user is available for text communication and voice communication, and partly available for video communication. In another example, RGB (30, 144, 255) may result in a shade of dodger blue being displayed, which may indicate that the user is highly available for video communication, partly available for voice communication, and not very available for text communication.

US process 12 may store 110 values of at least one of the text availability index, the voice availability index, and the video availability index over a historical trend time period (e.g., historical trend time period 418). Further, US process 12 may calculate 112 at least one of a text availability metric (e.g., text availability metric 412) based upon, at least in part, the stored values of the text availability index over the historical trend time period (e.g., historical trend time period 418), a voice availability metric (e.g., voice availability metric 414) based upon, at least in part, the stored values of the voice availability index over the historical trend time period (e.g., historical trend time period 418), and a video availability metric (e.g., video availability metric 416) based upon, at least in part, the stored values of the video availability index over the historical trend time period (e.g., historical trend time period 418). US process 12 may also provide 114 an indication (e.g., via the percentages shown in popup 410) of at least one of the text availability metric (e.g., text availability metric 412), the voice availability metric (e.g., voice availability metric 414), and the video availability metric (e.g., video availability metric 416). The indication may correspond, at least in part, to a historical likelihood of the user to be available for at least one of text communication, voice communication, and video communication.

For example, a user may wish to know Bobby's trend for being available via text communication over the last 6 months (e.g., historical trend time period 418). Text availability metric 412 may indicate that 70% of the time, Bobby's text availability index corresponds to a dark shade of red. In other words, Bobby may be highly available for text communication 70% of the time. Further, voice availability metric 414 may indicate that 80% of the time, Bobby's voice availability index corresponds to a medium shade of green. In other words, Bobby may have a medium level of availability for voice communication 80% of the time. Moreover, video availability metric 416 may indicate that 95% of the time, Bobby's video availability index corresponds to a light shade of blue. In other words, Bobby may have a low level of availability for video communication 95% of the time. A user viewing popup 410 may decide after viewing text availability metric 412, voice availability metric 414, and video availability metric 416, that generally the best way to get in touch with Bobby may be via text communication. Additionally, while text color shade 402, voice color shade 404, video color shade 406, text availability metric 412, voice availability metric 414, and video availability metric 416 are shown as being displayed in popup 410, this is for illustrative purposes only and other variations are possible. For example, one or more of text color shade 402, voice color shade 404, video color shade 406, text availability metric 412, voice availability metric 414, and video availability metric 416 may be displayed in contact list 322 itself in place of or in addition to the availability status icon and/or the combined color shade. For example, smaller indications of one or more of text color shade 402, voice color shade 404, video color shade 406, text availability metric 412, voice availability metric 414, and video availability metric 416 may be displayed over or around the availability status icon and/or the combined color shade (e.g., combined color shades 330, 332, and 334) in contact list 322.

In an implementation US process 12 may identify 116 a facial expression trend based upon, at least in part, the activity data (e.g., video input data). For example, US process 12 may identify a facial expression shown by a user most of the time. When the user shows this facial expression, it may indicate a normal facial expression for the user, and may further indicate that the user may be willing to accept electronic communication. Further, US process 12 may identify a deviation from the user's normal facial expression or facial expression trend. Such a deviation, or change in the user's facial expression as recognized by US process 12 may indicate that the user is less willing to accept electronic communication. US process 12 may provide 118 an indication of a deviation from the facial expression trend if a detected facial expression deviates from the facial expression trend. In this way, US process 12 may inform others that the user's facial expression has deviated from the normal facial expression, and that the user may be less willing to accept electronic communications at this time.

As will be appreciated by one skilled in the art, aspects of the present invention may be embodied as a system, apparatus, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer (i.e., a client electronic device), partly on the user's computer, as a stand-alone software package, partly on the user's computer and partly on a remote computer or entirely on the remote computer or server (i.e., a server computer). In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention may be described with reference to flowchart illustrations and/or block diagrams of methods, apparatus (systems) and/or computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures may illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Further, one or more blocks shown in the block diagrams and/or flowchart illustration may not be performed in some implementations or may not be required in some implementations. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

A number of embodiments and implementations have been described. Nevertheless, it will be understood that various modifications may be made. Accordingly, other embodiments and implementations are within the scope of the following claims.

What is claimed is:

1. A method comprising:
receiving, via a computing device, activity data from at least one of an audio input device, a video input device, and a command input device;
calculating a text availability index corresponding, at least in part, to a likelihood of a user to be available for text communication, a voice availability index corresponding, at least in part, to a likelihood of the user to be available for voice communication, and a video availability index corresponding, at least in part to a likelihood of the user to be available for video communication, wherein at least one of the text availability index, the voice availability index, and the video availability index is based upon, at least in part, the activity data; and
rendering a graphic indicator associated with the text availability index, the voice availability index, and the video availability index, wherein the graphic indicator indicates, at least in part, the likelihood of the user to be available for text communication, the likelihood of the user to be available for voice communication, and the likelihood of the user to be available for video communication.

2. The method of claim 1, wherein the graphic indicator includes a text color shade associated with the text availability index, the text color shade indicating, at least in part, the likelihood of the user to be available for text communication, a voice color shade associated with the voice availability index, the voice color shade indicating, at least in part, the likelihood of the user to be available for voice communication, and a video color shade associated with the video availability index, the video color shade indicating, at least in part, the likelihood of the user to be available for video communication.

3. The method of claim 1, wherein the graphic indicator includes a combined color shade, the combined color shade based upon, at least in part, the text availability index, the voice availability index, and the video availability index, the combined color shade indicating, at least in part, the likelihood of the user to be available for text communication, the likelihood of the user to be available for voice communication, and the likelihood of the user to be available for video communication.

4. The method of claim 1, further comprising:
storing values of at least one of the text availability index, the voice availability index, and the video availability index over a historical trend time period;
calculating at least one of:
a text availability metric based upon, at least in part, the stored values of the text availability index over the historical trend time period;
a voice availability metric based upon, at least in part, the stored values of the voice availability index over the historical trend time period; and
a video availability metric based upon, at least in part, the stored values of the video availability index over the historical trend time period; and
providing an indication of at least one of the text availability metric, the voice availability metric, and the video availability metric, the indication corresponding, at least in part, to a historical likelihood of the user to be available for at least one of text communication, voice communication, and video communication.

5. The method of claim 1, further, comprising:
identifying a facial expression trend based upon, at least in part, the activity data; and
providing an indication of a deviation from the facial expression trend if a detected facial expression deviates from the facial expression trend.

6. The method of claim 1, wherein at least one of the text availability index corresponding, at least in part, to the likelihood of a user to be available for text communication, the voice availability index corresponding, at least in part, to the likelihood of the user to be available for voice communication, and the video availability index corresponding, at least in part to the likelihood of the user to be available for video communication is further based upon, at least in part, at least one of processor utilization, network speed, a scheduled calendar meeting, and a screen lock status.

7. The method of claim 3, wherein the graphic indicator including the combined color shade that indicates, at least in part, the likelihood of the user to be available for text communication, the likelihood of the user to be available for voice communication, and the likelihood of the user to be available for video communication, is displayed in an availability status icon associated with an instant message application, the instant message application configured for text communication, voice communication, and video communication.

8. A computer program product residing on a computer readable storage medium having a plurality of instructions stored thereon, which, when executed by a processor, cause the processor to perform operations comprising:
receiving activity data from at least one of an audio input device, a video input device, and a command input device;
calculating a text availability index corresponding, at least in part, to a likelihood of a user to be available for text communication, a voice availability index corresponding, at least in part, to a likelihood of the user to be available for voice communication, and a video availability index corresponding, at least in part to a likelihood of the user to be available for video communication, wherein at least one of the text availability index, the voice availability index, and the video availability index is based upon, at least in part, the activity data; and
rendering a graphic indicator associated with the text availability index, the voice availability index, and the video availability index, wherein the graphic indicator indicates, at least in part, the likelihood of the user to be available for text communication, the likelihood of the user to be available for voice communication, and the likelihood of the user to be available for video communication.

9. The computer program product of claim 8, wherein the graphic indicator includes a text color shade associated with the text availability index, the text color shade indicating, at least in part, the likelihood of the user to be available for text communication, a voice color shade associated with the voice availability index, the voice color shade indicating, at least in part, the likelihood of the user to be available for voice communication, and a video color shade associated with the video availability index, the video color shade indicating, at least in part, the likelihood of the user to be available for video communication.

10. The computer program product of claim 8, wherein the graphic indicator includes a combined color shade, the combined color shade based upon, at least in part, the text availability index, the voice availability index, and the video availability index, the combined color shade indicating, at least in part, the likelihood of the user to be available for text communication, the likelihood of the user to be available for voice communication, and the likelihood of the user to be available for video communication.

11. The computer program product of claim 8, further comprising instructions for:
storing values of at least one of the text availability index, the voice availability index, and the video availability index over a historical trend time period;
calculating at least one of:
a text availability metric based upon, at least in part, the stored values of the text availability index over the historical trend time period;
a voice availability metric based upon, at least in part, the stored values of the voice availability index over the historical trend time period; and
a video availability metric based upon, at least in part, the stored values of the video availability index over the historical trend time period; and
providing an indication of at least one of the text availability metric, the voice availability metric, and the video availability metric, the indication corresponding, at least in part, to a historical likelihood of the user to be available for at least one of text communication, voice communication, and video communication.

12. The computer program product of claim 8, further comprising instructions for:
identifying a facial expression trend based upon, at least in part, the activity data; and
providing an indication of a deviation from the facial expression trend if a detected facial expression deviates from the facial expression trend.

13. The computer program product of claim 8, wherein at least one of the text availability index corresponding, at least in part, to the likelihood of a user to be available for text communication, the voice availability index corresponding, at least in part, to the likelihood of the user to be available for voice communication, and the video availability index corresponding, at least in part to the likelihood of the user to be available for video communication is further based upon, at least in part, at least one of processor utilization, network speed, a scheduled calendar meeting, and a screen lock status.

14. The computer program product of claim 10, wherein the graphic indicator including the combined color shade that indicates, at least in part, the likelihood of the user to be available for text communication, the likelihood of the user to be available for voice communication, and the likelihood of the user to be available for video communication, is displayed in an availability status icon associated with an instant message application, the instant message application configured for text communication, voice communication, and video communication.

15. A computing system comprising:
at least one processor;
at least one memory architecture coupled with the at least one processor;
a first software module executable by the at least one processor and the at least one memory architecture, wherein the first software module is configured to receive activity data from at least one of an audio input device, a video input device, and a command input device;
a second software module executable by the at least one processor and the at least one memory architecture, wherein the second software module is configured to calculate a text availability index corresponding, at least in part, to a likelihood of a user to be available for text communication, a voice availability index corresponding, at least in part, to a likelihood of the user to be available for voice communication, and a video availability index corresponding, at least in part to a likelihood of the user to be available for video communication, wherein at least one of the text availability index, the voice availability index, and the video availability index is based upon, at least in part, the activity data; and
a third software module executable by the at least one processor and the at least one memory architecture, wherein the third software module is configured to render a graphic indicator associated with the text availability index, the voice availability index, and the video availability index, wherein the graphic indicator indicates, at least in part, the likelihood of the user to be available for text communication, the likelihood of the user to be available for voice communication, and the likelihood of the user to be available for video communication.

16. The computing system of claim 15, wherein the graphic indicator includes a text color shade associated with the text availability index, the text color shade indicating, at least in part, the likelihood of the user to be available for text communication, a voice color shade associated with the voice availability index, the voice color shade indicating, at least in part, the likelihood of the user to be available for voice communication, and a video color shade associated with the video availability index, the video color shade indicating, at least in part, the likelihood of the user to be available for video communication.

17. The computing system of claim 15, wherein the graphic indicator includes a combined color shade, the combined color shade based upon, at least in part, the text availability index, the voice availability index, and the video availability index, the combined color shade indicating, at least in part, the likelihood of the user to be available for text communication, the likelihood of the user to be available for voice communication, and the likelihood of the user to be available for video communication.

18. The computing system of claim 15, further comprising:
a fourth software module executable by the at least one processor and the at least one memory architecture, wherein the fourth software module is configured to store values of at least one of the text availability index, the voice availability index, and the video availability index over a historical trend time period;
a fifth software module executable by the at least one processor and the at least one memory architecture, wherein the fifth software module is configured to calculating at least one of:
a text availability metric based upon, at least in part, the stored values of the text availability index over the historical trend time period;
a voice availability metric based upon, at least in part, the stored values of the voice availability index over the historical trend time period; and
a video availability metric based upon, at least in part, the stored values of the video availability index over the historical trend time period; and
a sixth software module executable by the at least one processor and the at least one memory architecture, wherein the sixth software module is configured to provide an indication of at least one of the text availability metric, the voice availability metric, and the video availability metric, the indication corresponding, at least in part, to a historical likelihood of the user to be available for at least one of text communication, voice communication, and video communication.

19. The computing system of claim 15, further comprising:
a seventh software module executable by the at least one processor and the at least one memory architecture, wherein the seventh software module is configured to identify a facial expression trend based upon, at least in part, the activity data; and
an eighth software module executable by the at least one processor and the at least one memory architecture, wherein the eighth software module is configured to provide an indication of a deviation from the facial expression trend if a detected facial expression deviates from the facial expression trend.

20. The computing system of claim 15, wherein at least one of the text availability index corresponding, at least in part, to the likelihood of a user to be available for text communication, the voice availability index corresponding, at least in part, to the likelihood of the user to be available for voice communication, and the video availability index corresponding, at least in part to the likelihood of the user to be available for video communication is further based upon, at least in part, at least one of processor utilization, network speed, a scheduled calendar meeting, and a screen lock status.
